(19) United States
(12) Patent Application Publication
(10) Pub. No.: US 2025/0380282 A1
(43) Pub. Date: Dec. 11, 2025

(54) METHOD AND SYSTEM FOR CONVEYING MULTIPLE COMPONENT SIGNALS AS A COMBINED SIGNAL IN A COMMON FREQUENCY BAND

(71) Applicant: ELTA SYSTEMS LTD., Ashdod (IL)

(72) Inventors: Itai BAR ZIV, Gedera (IL); Itay FUCHS, Nes Ziona (IL)

(21) Appl. No.: 18/878,485

(22) PCT Filed: May 30, 2023
(86) PCT No.: PCT/IL2023/050555

§ 371 Date: Dec. 23, 2024

(30) Foreign Application Priority Data
Jun. 27, 2022 (IL) 294326

(51) Int. Cl. H04W 72/30; H04H 20/51; H04H 20/74; H04W 72/56

(52) U.S. Cl. CPC H04W 72/30; H04W 72/56; H04H 20/51; H04H 20/74

(57) ABSTRACT

Method and system for conveying a plurality of component signals transmitted from a multi-waveform transmitter to a ground hub having or coupled to an equal plurality of receivers as a combined signal in a common frequency band. For each of the component signals respective adjusted signals are generated by adjusting at least one inherent characteristic of the respective component signals based on waveform-specific constraints so as to allow discrimination of the adjusted signals by a respective one of the receivers based solely on the at least one inherent characteristic without requiring additional signal information and without requiring encoding of the component signals by the transmitter. The adjusted signals are combined in a common frequency band to form a combined signal. and transmitted to the ground hub.

### FIELD OF THE INVENTION

This invention relates generally to data communication systems and methods and in particular to satellite communication.

### BACKGROUND OF THE INVENTION

Satellites are relay stations in space for the transmission of voice, video and data communications. In a typical broadcast scenario, an uplink Earth station or other ground equipment transmits a modulated signal to the satellite, which amplifies the incoming signal, changes the frequency and transmits this signal back to Earth where it may be received by single or multiple terminals (subscribers). For example, the uplink Earth station may be associated with a cable broadcast company which transmits video programs to multiple subscribers each having an antenna in the form of a satellite dish directed toward the satellite for receiving broadcast signals. In this scenario the satellite is typically a geostationary satellite, which rotates at the same speed as the Earth and therefore maintains a fixed position in space relative to the Earth. By this means, the subscribers' ground antennas can also be stationary and yet remain in proper spatial disposition in space for receiving the satellite broadcast signals.

In practice, many different and even competing broadcast companies use the same satellite for relaying their broadcasts to respective subscribers. This can be done by transmitting each signal in a different frequency band, but is inefficient owing to the high bandwidth required to transmit all the signals, which may result in high cost due to unavailability of spectrum. Therefore, techniques are known that allow multiple broadcast signals to be relayed by satellite to respective ground stations in a common frequency band.

US2021195440 discloses a method for increasing bandwidth efficiency in satellite communications, comprising receiving, at a satellite and from a plurality of user ground terminals, a plurality of source signals each modulated according to at least one source modulation method, and further receiving, at a satellite and from a plurality of user ground terminals, a plurality of information signals corresponding to the plurality of source signals. At the satellite, each of the plurality of source signals is modulated according to at least one predetermined modulation method and combined to form a combined source signal with an overlapping bandwidth, which is transmitted, by a downlink transmission from the satellite to a gateway ground station. In one embodiment, the downlink transmission comprises information specifying at least one modulation method, in addition to the modulated combined signals, in order to have the ability to extract each one of the component signals. Each of the component signals is successively canceled in order to extract and demodulate the rest of the signals. In such manner, respective ground stations belonging to different broadcast companies such as TV cable providers, can all receive the same composite signal from a single broadcast satellite and each extract their proprietary signal for onward broadcast to their respective subscribers.

A drawback of the approach adopted in US2021195440 is that in addition to the data transmitted in each channel there is a need to include secondary information that allows the receiver to know the kind of modulation applied to the data thereby allowing the receiver to extract the data.

In order for this drawback to be better understood, consider a possibly imaginary scenario where a TV cable company has acquired proprietary rights for the live broadcast of a football match. They set up a number of different mobile cameras in the stadium: one configured for real-time imaging of the players; a second for imaging the referee; a third for imaging the supporters; and so on. There might also be separate channels for broadcasting sound from a commentator and crowd reaction. Thus, there are generated multiple concurrent channels pertaining to different aspects of the game, and the TV cable company now wishes to transmit these channels to its subscribers based on different subscription scales. So, some high-level subscribers may be provided with all three images with commentary while lower-level subscribers may be provided with views of the game but without either or both of the supplementary images and possibly without commentary.

In accordance with the approach used by US2021195440 this typically requires that all channels be broadcast to a satellite, which modulate the broadcasts using different modulation techniques and then transmit all the modulated signals each with respective modulation information signals in a common frequency band to a ground hub or gateway. The gateway would use the modulation information signals to demodulate the component signals, which could then be conveyed to their respective subscribers. In a practical implementation, the combined information signal is transmitted at a frequency immediately adjacent to the frequency used to transmit the combined source signal or in a separately allocated sub-channel or frequency.

This increases both the volume of data that needs to be transmitted and the required frequency bandwidth. But even more significantly, it requires prior coordination between the satellite and receiving stations because each receiver must be preconfigured to extract the individual information signals, which it then uses to extract and demodulate the component signals. The individual information signals and underlying information related to each component signal may also be extracted and utilized for subsequent processing and routing of the signals. This requirement is not so much of a problem for the approach adopted by US2021195440 because the modulation and combination of the component signals are performed by the satellite, whose owner can thus dictate to its registered users the relevant conditions for uplink and downlink communication. Specifically, all such users must embed in their receivers a suitable DSP that extracts the individual information signals and uses them to extract and demodulate the component signals.

A satellite owner can yield such power and set custom-specific standards for its users. But this does not address the need for multiple all-purpose transmitters to convey respective source signals via a relay station to multiple receivers as a combined signal in a common frequency band in a manner that permits the receivers to extract the source signals, without the need to transmit ancillary information alongside the source signals.

### SUMMARY OF THE INVENTION

It is an object of the present invention to address this requirement.

To this end, there is provided in accordance with one aspect of the invention a method for conveying a plurality of component signals transmitted from a multi-waveform transmitter to a ground hub having or coupled to an equal plurality of receivers as a combined signal in a common frequency band, the method comprising:
(a) for each of the component signals generating respective adjusted signals by adjusting at least one inherent characteristic of the respective component signals based on waveform-specific constraints so as to allow discrimination of the adjusted signals by a respective one of the receivers based solely on the at least one inherent characteristic without requiring additional signal information and without requiring encoding of the component signals by the transmitter;
(b) combining the adjusted signals in a common frequency band to form a combined signal; and
(c) transmitting the combined signal to the ground hub.

The adjusted inherent characteristic of each component signal considers the overall constraints of the transmitter, and optionally local and remote prioritization and waveform constraints. The component signals in the transmitted combined signal are discriminated by the receiver based only on the relative hierarchy of the inherent characteristic without needing to transmit additional signal information with the combined signal. In practice, this means that the ground hub receives a unitary signal containing multiple component signals. Some or all of the component signals may be of the same type, e.g., DVB-S (Digital Video Broadcasting for satellite television); but more generally at least some of the component signals will be of different modulation types and therefore directed to different types of end receiver. Conversely, component signals of the same type will be directed to receivers of the same type, but will be distinguished only by virtue of having different values of the chosen inherent characteristic, which in some embodiments is signal strength.

Where the invention is distinguished over known approaches resides principally in the fact that the multi-wave transmitter combines the component signals according to a hierarchy, so that the component signals within the combined signal are successively less dominant.

In one embodiment, the characteristics of the respective receivers include power levels and discrimination between the different component signals is a function of the power level of each component signal. In such manner, the component signals may be configured to have discriminable power levels allowing for their separation by a receiver station prior to onward transmission to respective receiver terminals. This approach allows multiple signals to be transmitted together in a common frequency band without the need for customized pre-modulation and without the need to transmit concomitant modulation information as is done in the prior art, thus resulting in simpler more cost-effective transmission while preserving the benefits of reduced frequency bandwidth. In some embodiments, the ground hub conveys the combined signal to all the receivers, only one of which is configured to extract the dominant signal. The remaining receivers receive the combined signal as noise. The one receiver that is able to extract the dominant signal directs it to an output receiver for onward broadcasting to relevant subscribers and then removes the dominant signal from the received combined signal. This produces a reduced signal, which for all except the last signal, will also have multiple components and a single dominant signal, which is then conveyed to all the receivers. This is repeated until all component signals are extracted by their respective receivers and directed to corresponding output receivers. For each recursion, the most dominant signal is the component for which the value of the selected inherent characteristic is maximum.

Such an approach is not only different but also exhibits surprising benefits over conventional approaches such as CDMA. First, as noted above, no additional information need be sent with the combined signal to enables its unpacking by the ground hub or by any of the receivers therein. Secondly, the transmitter can combine two or more signals of identical modulation type but having distinctive ranges of a chosen inherent characteristic, such as signal strength. By way of simple example, we will consider transmission of only two signals of identical modulation type. Such a combined signal is fed to two different receivers, each configured to extract only one of the component signals of appropriate signal strength and each coupled to its respective output receiver, one of which will broadcast the dominant signal to its intended subscribers and the other of which will broadcast the less dominant signal to its intended subscribers. Significantly, each receiver in the ground hub receives all the component signals and yet extracts only the one component signal for which it is matched without the need for a priori knowledge or additional information.

It will be appreciated that in the simplified example described above, all the channel transmitters are substantially stationary and therefore their positions relative to a receiving station or hub are, to all practical purposes, invariant. However, in other scenarios, signals may be transmitted by mobile terminals such that the signal strengths of the respective channels vary according to the relative position of the mobile terminals to the receiving station or hub.

Moreover, as will become evident from the following detailed description, other transmitter characteristics apart from power level may be utilized additionally or alternatively and applied to the component signals prior to combination and transmission.

It will also be understood that the invention is distinguished from conventional CDMA, which also allows a combined signal formed from multiple component signals to be transmitted in a common frequency band. Most significantly, CDMA encodes the component signals before combining them, typically using mutually orthogonal codes, each of which must be used by the respective receiver to extract the required component signal. This means that correlation or cross-correlation between the component signals is required for each receiver to be able to decode its required signal. As will become apparent from the following description, there is no such requirement in the approach according to the invention.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a pictorial representation showing a multi-waveform transmitter for transmitting multi-waveform signals to a receiver via a satellite relay;

FIGS. 2a to 2d are a flow chart showing details of a method according to the invention for adjusting power levels of component signals prior to their combination;

FIG. 3 is a pictorial representation showing satellite beam coverage patterns;

FIGS. 4a and 4b are a table showing adjusted power levels assigned to three component signals in accordance with an embodiment of the invention; and

FIG. 5 is a block diagram showing functionality of a receiver bank configured to extract/separate the three component signals for the embodiment of FIGS. 4a and 4b.

### DETAILED DESCRIPTION OF EMBODIMENTS

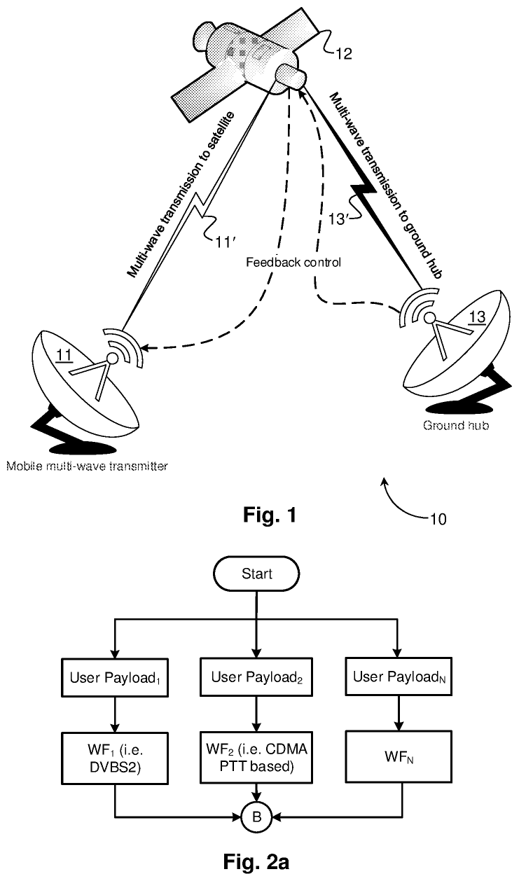

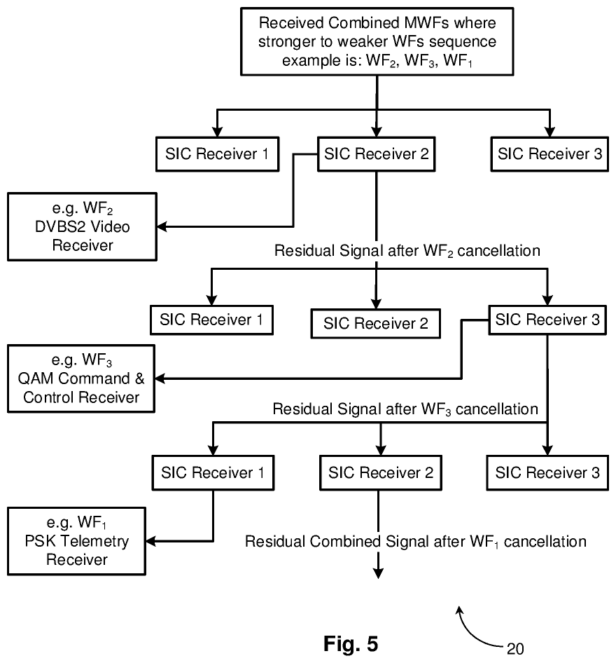

FIG. 1 is a pictorial representation of a system 10 showing a multi-waveform transmitter 11 configured to combine multiple component or constituent signals and transmit the resulting combined signal via an uplink channel 11′ to a satellite 12, which relays the combined signal to a ground hub 13 via a downlink channel 13′. The satellite 12 acts as a dumb terminal that merely relays the component signals without change. The transmitter 11 generates for each of the component signals respective adjusted signals by adjusting at least one inherent characteristic of the respective component signals so as to allow discrimination of the adjusted signals by a bank of receivers 20 (shown in FIG. 5) in the ground hub 13 based solely on the at least one inherent characteristic. In some embodiments, the inherent characteristic is a power level and the transmitter 11 adjusts the power level of each of the component signals so that they can be discriminated at the receiver based on power level alone allowing the component signals to be successively removed using signal cancellation.

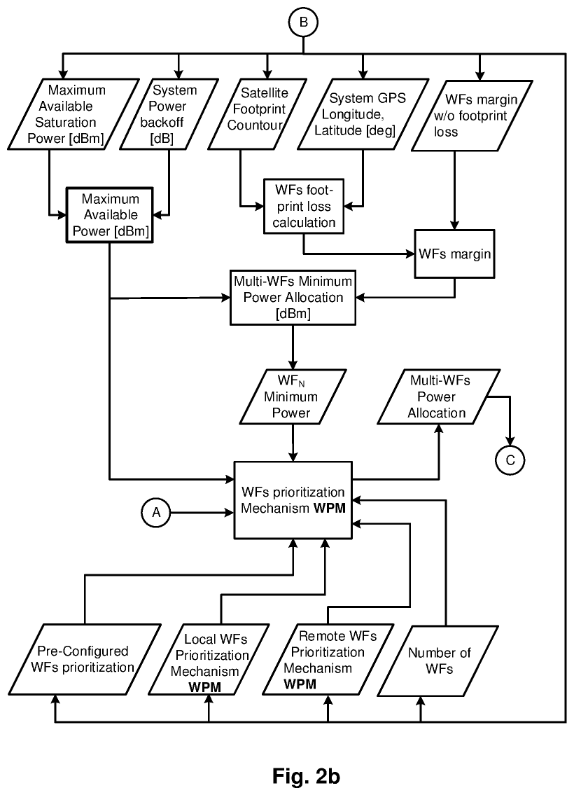

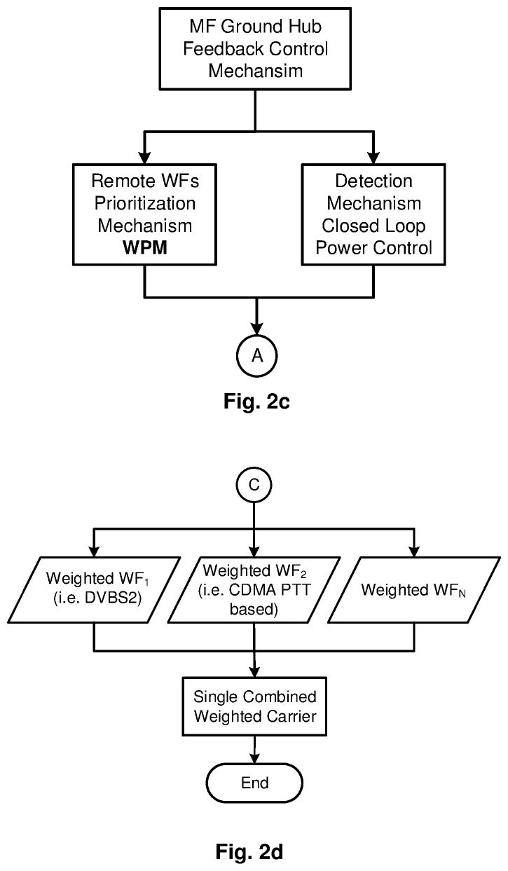

FIGS. 2a to 2d are a flow chart showing details of a method as well as the functional components according to the invention for adjusting power levels of component signals prior to their combination. For better understanding, it is noted that rhombus elements relate to parameters that are derived from external sources; while rectangular elements are processes that receive data either in the form of parameters or as outputs from other processes and perform calculations to compute the weighting applied to signal characteristics.

Thus, referring to the figures, there are shown three user payloads, these being the component signals depicted by waveforms WF₁, WF₂ to WF_{N} where by way of example N is equal to 3. Also, by way of example, the three waveforms are assumed to conform to different communication modulations. Thus, WF₁ may be a video signal conforming to DVB-S2, which is digital television broadcast standard commonly used for DVB-S satellite communication; WF₂ may conform to the CDMA PTT (Push-to-Talk) modulation; WF₃ could be used for low rate transmission such as audio signal application and so on. However, the signals do not need to have different modulations since signal discrimination is based on an inherent characteristic of the signals as opposed to a subsequent change to the signals such as produced using signal modulation. Indeed, this feature of the invention is a major departure from the approach adopted by US2021195440.

A Detection Mechanism in the ground hub receives the component source signals 15′ from the satellite 14 and may operate a Closed Power Loop control, which feeds the received signal power level back to the multi-waveform transmitter via the satellite as shown in FIG. 1 using dashed lines to allow the multi-waveform transmitter to adjust its weighted transmitted power. By this means, if the received signal intensity is too low, the multi-waveform transmitter will automatically increase it; while if the received signal intensity is unnecessarily high, the multi-waveform transmitter will automatically decrease it.

The multi-waveform transmitter 11 may be configured to assign priorities based on pre-configured prioritization settings either local or remote prioritization settings as shown in FIG. 2b. In the case of remote prioritization, the ground hub 13 is configured to feed remote prioritization data to the multi-waveform transmitter 11 via the satellite 14 to allow the transmitter to adjust its weighted transmitted power according to a hierarchy of recursion levels determined by the ground hub.

The local WFs Prioritization Mechanism (WPM) is a mandatory feature where the transmitter assigns different power levels to the different waveforms in percentage of the total maximum available power.

Alternatively, or additionally, the WPM could be adjusted from the remote ground Hub. The Remote WPM shown in FIG. 2c is an optional feature whereby the Ground Hub Feedback Mechanism assigns priorities to the transmitted signals. In the case when two or more signals having identical modulation are combined but must each be sent to only designated recipients, any such assignment must be made in concert with the receivers so that the correct receivers will receive the designated signals, as explained in greater detail below with reference to FIG. 5. For the sake of abundant clarity, it should be noted that the term ‘priority’ is not intended to imply that one signal is more important than another but only that its respective signal characteristic, such as signal power, is higher in the hierarchy and thus has a lower (i.e. earlier) recursion level so that it is dominant and therefore extracted before other signals.

Maximum Available Saturation Power [dBm] is an input to the weighting algorithm specifying the total power that can be transmitted before reaching saturation. In practice, the transmitter never transmits at the maximum power so as to avoid the risk of going into saturation. System Power backoff defines a logarithmic factor in dB by which the maximum available saturation power is reduced in order to ensure that some power is held in reserve and to ensure that transmitter power stays in the linearity operating area, thereby reducing the maximum available power that can be transmitted to avoid saturation. Specifically, if the calculation will require that a certain waveform transmitted increases its power beyond the linear range, the system must ignore it. By way of example, the System Power backoff is set to 3 dB, which is equivalent to transmitting at half its maximum saturation power, as explained below.

Thus, Maximum Available Power [dBm] is the total power that can be transmitted in practice given by:

$$B = 10 {log}_{10} ( \frac{{P}_{sat}}{{P}_{max}} ) \qquad ( 1 )$$

where: Pₛₐₜ is the maximum available saturation power;
   Pₘₐₓ is the maximum available power (to avoid any risk of saturation); and
   B is the System Power backoff in dB

In the case where B=3, this gives:

$${P}_{max} = \frac{{P}_{sat}}{{10}^{( \frac{3}{10} )}} \approx \frac{{P}_{sat}}{2} \qquad ( 2 )$$

In other words, we preferably transmit at half the maximum available saturation power, although this method can be applied for system with no back-off (maximum power at saturated levels).

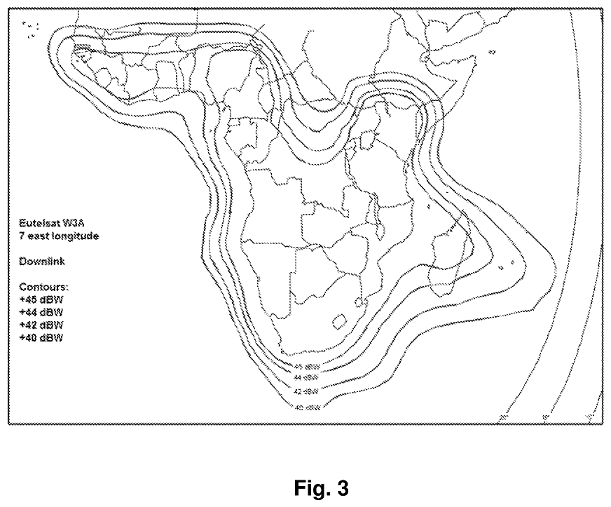

Satellite Footprint Contour is a factor that compensates for changes in the satellite antenna directivity. Signals are received at the satellite receiver and are transmitted by its transmitter at maximum signal strength when the satellite antennas are in direct line of sight with the complementary transmitters and receivers. FIG. 3 is a contour map of the kind published by a satellite owner showing the EIRP at locations within the satellite's footprint, or intended area of coverage. EIRP is the equivalent (or effective) isotropic radiated power, and is the total radiated power from a transmitter antenna times the numerical directivity of the antenna in the direction of the receiver. If the transmitter is located within the area of maximum coverage, then transmission at a given available power will be sufficient. But if the transmitter moves to a different location outside the area of maximum coverage, then we need to increase the transmission power, up to Pₘₐₓ (as defined above), to ensure that it will be received by the satellite. Similarly, if the receiver at the ground hub moves to a different location outside the area of maximum coverage, then we need to increase the transmission power to ensure that a signal transmitted by the satellite will be received at sufficient signal strength by the ground hub. It should be noted that for each satellite, the EIRP contours may be different for uplink and downlink communication.

WFs foot-print loss calculation calculates the effective power level to compensate for transmission outside of the area of maximum coverage of the satellite. This is simply the ratio of the dB values of the contour corresponding to maximum coverage to the contour corresponding to the transmitter location. If the invention is applied to a system employing mobile transmitters such as but not limited to airborne terminals, the uplink transmitters could cross contours and thus require constant power compensation to ensure that a signal of suitable amplitude is conveyed to the satellite.

WFs margin w/o footprint loss defines a margin corresponding to a power loss that can be accommodated according to changes in environmental conditions without loss of signal. For example, this allows for compensation for reduced signal strength owing to degraded visibility caused by clouds or dust storms.

WFs margin is a processing element, which is typically implemented in software and computes the effective margin that takes into account both the foot-print loss and the environmental loss.

Pre-Configured WFs prioritization is an optional processing element typically implemented in software that is used in some embodiments to set the priority of the component signals globally, thus obviating the need for handshaking between the Ground Hub Feedback Mechanism and the receiver terminals that is required when Remote WFs Prioritization Mechanism WPM is used.

WFs prioritization Mechanism (WPM) is a processing element typically implemented in software that takes all the preconfigured and computed parameters described above and determines the transmission power of each component signal.

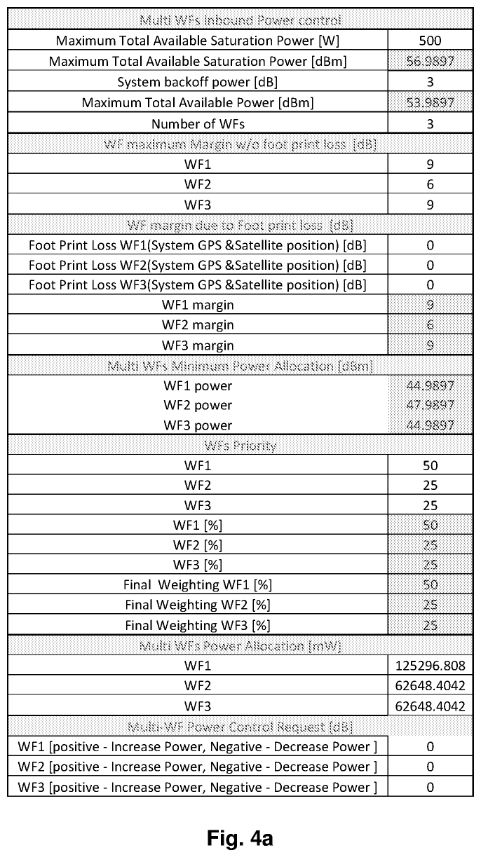

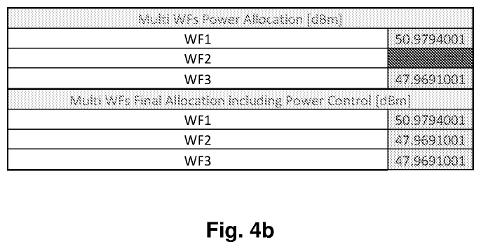

FIGS. 4a and 4b are a table showing adjusted power levels assigned to three component signals in accordance with an embodiment of the invention. The table is part of a spreadsheet whose cells are programmed to compute results based on values entered into cells in preceding rows of the table or based on formulas associated with cells in preceding rows of the table. In a developmental pilot, this was implemented using Microsoft Excel™, but in practice it is more easily implemented by the waveform prioritization mechanism (WPM) in FIG. 2b using software or firmware and possibly having a suitable user-interface for entering system parameters such as Maximum Total Available Saturation Power. Alternatively, the parameters can be either embedded or pre-loaded without a requirement for user interaction. Nevertheless, it is convenient to describe the waveform prioritization mechanism with reference to the table, since it uses easily-recognizable parameter names rather than program variables.

The WPM algorithm receives as an input the Maximum Total Available Saturation Power, Pₛₐₜ set to 500 W. This is converted to the equivalent power in dBm as follows:

$$\begin{matrix}{P}_{sat} = 500 W \\ = 500 , 000 mW \\ = 10 {log}_{10} 500 , 000 \\ = 56.9897 dBm\end{matrix} \qquad ( 3 )$$

Since log₁₀1,000=30, this is equivalent to 30+10log₁₀500.

System Backup Power is set to 3 dB. Consequently, the maximum available power Pₘₐₓ in [dBm] is given by:

$$\begin{matrix}{P}_{max} = {P}_{sat} - 3 \\ = 53.9897 dBm\end{matrix} \qquad ( 4 )$$

We now specify the number of waveforms, i.e., 3. This parameter is used in the spreadsheet application because it opens up the requisite number of rows. But it merely serves as a vehicle for entering the requisite margins and footprint losses for each waveform.

As can be seen from the table the following input parameters are entered:

WF maximum Margin w/o footprint loss, which we will denote by Mₑₙᵥ (since it relates to environmental losses) and WF margin due to satellite footprint loss, denoted by Lₛₐₜ. The effective margin M for each waveform, WFₙ, is then determined as:

$${M}_{n} = {M}_{e n {v}_{n}} - {L}_{{sat}_{n}} \qquad ( 5 )$$

where n is the waveform index i.e., 1 to 3 in our case.

This allows computation of the Minimum Power Allocation, MPA, for each waveform, WFₙ, as:

$$M P {A}_{n} = {P}_{{max}_{n}} - {L}_{{sat}_{n}} \qquad ( 6 )$$

The algorithm next requires that the relative priorities for each of the waveforms be specified or computed as percentages. For the three waveforms, the percentage priorities are set to 50, 25 and 25 respectively. In the spreadsheet, it is seen that absolute priorities are specified according to an unspecified metric and the percentage priorities are then computed.

However, since the absolute priorities as set add up to exactly 100, there is no difference between the absolute priorities and the relative percentage priorities. The final weightings including additional information such as inputs from the ground (marked as A in the diagram) correspond to the percentage priorities and will be denoted by FWₙ where n is the waveform index.

Multi WFs Power Allocation [mW] denoted by P_{A-mw}_{_{y}}, for each waveform, WFn, is then determined as:

$${P}_{A - m {w}_{n}} = ( \frac{F {W}_{n}}{100} ) \times {10}^{( \frac{{P}_{max}}{10} )} \qquad ( 7 )$$

This gives the following values:

$$\begin{matrix}{P}_{A - m {w}_{1}} = 125296.8 \; 08 [ mW ] \\ {P}_{A - m {w}_{2}} = 62648.4 \; 04 [ mW ] \\ {P}_{A - m {w}_{3}} = 62648.4 \; 04 [ mW ]\end{matrix} \qquad ( 8 )$$

The Multi-WF Power Control Request [dB] (PCRₙ) is a message conveyed by a transmitter (not shown) in the ground hub (relevant only for WFs that support closed loop power control) and received by the multi-wave transmitter via the satellite. The algorithm considers dynamically each separate power control request to each WF and combines each request into the final weighting power allocation where applicable (under the above power limitation constraint and WFs prioritization). The Power Control Request is based on dynamic evaluation quality of the detected WF (only for supported WF) such as

Received Signal Strength Identification (RSSI), Bit Error Rate (BER), Signal to Noise Ratio (SNR) etc. According to these criteria, the terminal WF receiver receives power correction requests (can be to increase or decrease power) and provides the request to the WPM. In the flow chart it can be found under the Ground MWF (FIG. 2c) handling as Closed Loop Power Control.

The power allocation values in [mW] are converted to dBm as follows:

$${P}_{A - d B {m}_{n}} = 10 {log}_{10} ( {P}_{A - m {w}_{n}} ) \qquad ( 9 )$$

This gives the following values:

$$\begin{matrix}{P}_{A - d B {m}_{1}} = 50.9794 [ dBm ] \\ {P}_{A - d B {m}_{2}} = 47.96 9 [ dBm ] \\ {P}_{A - d B {m}_{3}} = 47.96 9 [ dBm ]\end{matrix} \qquad ( 10 )$$

The actual adjusted power level for each waveform corresponding to Final Allocation including Power Control [dBm] (PF_{A-dBm}_{ₙ}) is the sum of the above values and the Multi-WF Power Control Request [dB] (which can be negative). In other words:

$$\begin{matrix}P {F}_{A - d B {m}_{1}} = {P}_{A - d B {m}_{1}} - P C {R}_{1} \\ {PF}_{A - d B {m}_{2}} = {P}_{A - d {B}_{2}} - {PCR}_{2} \\ {P}_{F A - d B {m}_{3}} = {P}_{A - d B {m}_{2}} - P C {R}_{3}\end{matrix} \qquad ( 11 )$$

Since in the above-described embodiment, PCR₁, PCR₂ and PCR₃ are all zero, the final adjusted power values are the same as shown in Eqn. 11.

The above computations are carried out by the Waveform Prioritization Mechanism shown as WPM in FIG. 2b, whose output shown generally as Multi-WFs Power Allocation in FIG. 2b and is shown in expanded detail as separate weighted waveforms in FIG. 2d, is fed to the combiner shown in FIG. 2d, which combines all the waveforms in a single carrier for onward transmission in a single frequency band for receiving by a designated receiver system (shown functionally in FIG. 5).

The receiver unpacks the combined signal to obtain the original component signals. One way in which this can be done is using Successive Interference Cancellation (SIC), whereby the receiver decodes the strongest signal first, subtracting it from the combined signal and then decoding the weaker signal from the difference/residual combined signal and repeating this until all the component signals are extracted. This is a well-known technique and is not itself a feature of the invention, which is concerned only with the manner in which different source signals are combined at the multi waveform transmitter in such a manner as to allow the receiver to discriminate between the different component signals but without requiring supplementary information. By way of example only, the reader can refer to D. C. Araújo, A. M. P. Lucena and J. C. Moura Mota, “Successive interference cancellation algorithm in m-QAM nonorthogonal multicarrier systems,” 2014 International Telecommunications Symposium (ITS), 2014, pp. 1-5, doi: 10.1109/ITS.2014.6948049. The techniques disclosed in this article are directly appropriate only for QAM (Quadrature Amplitude Modulation) type signals, and may be modified to allow for successive cancellation of other types of modulation.

As noted above, the signals dedicated to each receiver may be specified either by the remote prioritization mechanism in the ground hub and/or are pre-configured according to the selected implementation of the invention. In either case, the ground hub and the multi-waveform transmitter remotely connected thereto are thereby able to identify the component signals according to their assigned or pre-configured priorities as established by the multi-waveform transmitter. In this connection, it is reiterated that the signals (and their respective priorities) are well known to the multi-waveform transmitter and optionally also to the ground hub feedback mechanism. Prioritization is only required to determine which component signal shall have more (or less) power than the other component signals in such way that the ground receivers bank will be able to unpack them without a priori knowledge of the sequence itself. This allows the ground MWF receiver to unpack the combined signal received from the multi-waveform transmitter in accordance with the signal assigned priority and provide each one of them to the appropriate WF receiver. Most significantly, the receiver does not require any ancillary information to unpack the designated signal, since discrimination of the adjusted component signals by the receiver is based solely on the at least one inherent characteristic of the component source signals.

FIG. 5 is a block diagram showing functionality of a receiver bank configured to extract the three component signals for the embodiment of FIGS. 4a and 4b. For ease of explanation, we assume that the receiver comprises a bank of receiver modules each configured to extract a signal of a specific type, i.e., modulation. So, for the case where the combined signal is formed of three constituent signals each conforming to a different modulation, we require three different receivers. By way of example, we assume that WF₁ is a PSK telemetry signal; WF₂ is a DVBS2 video payload signal; and WF₃ is a QAM Command & Control payload signal. We also assume that the sequence of stronger to weaker WFs is: WF₂, WF₃, WF₁ and that this sequence is known to the transmitter. Further, for ease of explanation, we will assume that there are as many banks of receivers as there are different types of waveforms. So, for three different types of waveforms, we require three receivers in each bank and three banks. But this is not a requirement since we could employ a single bank of receivers and, as the combined signal is successively reduced, recursively feed the reduced signal back to the three receivers until all the constituent signals are extracted.

It is seen that the combined signal is fed to all three SIC receivers, each of which tries to extract a component signal of a type that is appropriate to the respective receiver.

However, as explained above, the transmitter adjusts the signal strengths or power of each of the constituent signals to allow discrimination at the receiver. Consequently, the signal strength of the strongest signal WF₂ is higher than that of the next signal WF₃ and, of course, a fortiori than that of the next (and weakest) signal WF₁, that until the strongest signal, WF₂ is removed, the first and third receivers perceive the received signal as noise and are unable to extract their respective lower strength signals, WF₁ and WF₃.

So, in the first stage, only the second SIC receiver in the first bank is able to extract the DVBS2 video component i.e., WF₂ and remove it from the combined signal. The extracted signal WF₂ is fed to a designated output receiver configured to receive DVBS2 video signals from where it may then be directed in known manner to designated subscribers. The reduced signal fed to the second bank of receivers now comprises only two constituent signals, namely WF₁ and WF₃. The next strongest signal WF₃ extracted by the third SIC receiver in the second bank is now isolated and fed to a designated output receiver configured to receive QAM Command & Control signals from where it can be directed in known manner to designated subscribers. The last signal WF₁ extracted by the first SIC receiver in the third bank is now isolated and fed to a designated output receiver configured to receive PSK Telemetry signal from where it can be directed in known manner to designated subscribers. To this end, the SIC receivers in each bank of receivers need to be associated with the respective signal types or modulations for which they are configured, it being understood that in practice there may be more than one constituent signal of the same type, but with different signal strengths. In such a case, the receiver bank could contain multiple SIC receivers, each configured to decode one of these signals based on signal strength. So, for the case where the combined signal contains two or more combined constituent signals of identical type but with different signal strengths, a first designated SIC receiver would extract and remove the higher strength signal and a subsequent designated SIC receiver would extract and remove the lower strength signal, each of the SIC receivers feeding the respective extracted component to a different output receiver. The recursion levels may be assigned by the remote prioritization mechanism shown in FIG. 2c. In FIG. 5, each output receiver has associated therewith respective recipients to which the correct extracted signals are directed so that recipients cannot receive signals for which they are not intended or authorized. Alternatively, the receiver bank could have only a single SIC receiver for extracting both or all of these constituent signals, each feeding the respective component signal to a different output receiver. It has been noted that the receivers in each bank of receivers may need to be associated in advance with the respective signals for which they are configured. Each of the receivers is mapped to authorized subscribers so that each extracted signal is made available only to appropriate subscribers. It will be appreciated that the waveform related constraints are specific for a waveform or signal. For example, a QAM16 signal requires higher SNR at the receiver end than a QPSK signal. Therefore, the multi-waveform transmitter must allocate adequate power weight for each one to satisfy each waveform link budget. This can be done by defining a hierarchy at the transmitter in accordance with which the signal strengths of the respective constituent signals are adjusted.

Within the context of the invention and the appended claims, the term “inherent characteristic” refers to a property of the signal that is innate to the signal “as is” such as, for example, power level, phase, and frequency. The source signals may be modulated, but the very act of modulation changes the signal and requires demodulation in order to extract the original signal. Therefore, it cannot be regarded that modulation is an inherent or innate property or characteristic of the source signal.

The invention contemplates a computer program being readable by a computer for executing the method of the invention. The invention further contemplates a machine-readable memory tangibly embodying a program of instructions executable by the machine for executing the method of the invention. A system according to the invention may include a suitably programmed computer that executes the method as described.

It should also be noted that features that are described with reference to one or more embodiments are described by way of example rather than by way of limitation to those embodiments. Thus, unless stated otherwise or unless particular combinations are clearly inadmissible, optional features that are described with reference to only some embodiments are assumed to be likewise applicable to all other embodiments also.

The description of the above embodiments is not intended to be limiting, the scope of protection being provided only by the appended claims.

1.-31. (canceled)

32. A method for conveying a plurality of component signals transmitted from a multi-waveform transmitter via a satellite to a ground hub having or coupled to an equal plurality of receivers, the method comprising:
(a) for each of the component signals generating respective adjusted signals by adjusting a power level of the respective component signals based on waveform-specific constraints so as to allow discrimination of the adjusted signals by a respective one of the receivers based solely on the at least one inherent characteristic, wherein said adjusting the power level of the respective component is the only encoding which the receiver uses for distinguishing between the component signals;
(b) combining the adjusted signals in a common frequency band to form a combined signal; and
(c) transmitting the combined signal to the ground hub;
(d) determining directivity of the satellite relative to each of the receivers and to the multi-waveform transmitter,
(e) based on any deviation from direct line of sight between the satellite relative to the receivers and the multi-waveform transmitter, calculating an effective power level of the multi-waveform transmitter to compensate for transmission outside an area of maximum coverage of the satellite, and
(f) adjusting transmission power of the multi-waveform transmitter, up to a predetermined maximum available power, Pmax to ensure that the combined signal is received by the satellite and that a signal transmitted by the satellite will be received at sufficient signal strength by the ground hub.

33. The method according to claim 32, further including:
(g) providing a ground hub feedback mechanism for assigning priorities to the transmitted signals in concert with the receivers so as to allow two or more signals to be combined by the multi-waveform transmitter and detected only by their respective designated recipients; and
(h) conveying the priorities to the multi-waveform transmitter for adjusting the respective power level of the component signals based on the respective priorities.

341. The method according to claim 32, wherein each receiver is configured to detect a respective dominant signal from a received signal, to remove the dominant signal from the received signal, and to convey a resulting reduced signal to at least one remaining receiver; the received signal corresponding to the combined signal or to the combined signal from which at least one component signal has been removed.

35. The method according to claim 32, wherein each receiver receives the combined signal or a successively reduced combined signal in turn according to a predetermined recursion hierarchy known to the transmitter, each receiver being configured to detect only a respective dominant component signal.

36. The method according to claim 32, wherein the power level of each component signal is adjusted based on overall constraints of the transmitter and optionally signal waveform constraints.

37. The method according to claim 32, wherein the respective power level of the component signals is adjusted according to a hierarchy of recursion levels.

38. The method according to claim 32, wherein the multi-waveform transmitter adjusts a weighted transmitted power of the combined signal in response to signal power level for each component signal conveyed by a ground hub detection mechanism.

39. The method according to claim 32, wherein the multi-waveform transmitter adjusts a weighted transmitted power of the combined signal according to a hierarchy of recursion levels.

40. The method according to claim 32, wherein the power level is adjusted for each component signal according to a minimum signal-to-noise ratio (SNR) that the respective component signal can allow while permitting extraction of the signal.

41. The method according to claim 32, wherein maximum available power [dBm] corresponding to the total power that can be transmitted in practice is given by:
$$B = 10 {log}_{10} ( \frac{{P}_{sat}}{{P}_{max}} )$$
where: Pₛₐₜ is the maximum available saturation power;
Pₘₐₓ is the maximum available power (to avoid any risk of saturation); and
B is System Power backoff in dB.

42. The method according to claim 41, wherein the maximum available power is adjusted to compensate for changes in environmental conditions and/or satellite footprint changes.

43. The method according to claim 32, wherein the maximum available power is adjusted in response to a Multi-WF Power Control Request conveyed by channel transmitters.

44. The method according to claim 32, wherein the power level of each component signal is adjusted based on either local or remote prioritization settings.

45. A system comprising a multi-waveform transmitter transmitting a combined signal formed of component signals, via an uplink channel to a satellite configured to relay the combined signal to a ground hub via a downlink channel, wherein the multi-waveform transmitter generates for each of the component signals respective adjusted signals by adjusting power level of the respective component signals so as to allow discrimination of the adjusted signals by a receiver in or associated with the ground hub based solely on the power level, wherein adjusting the power level of the respective component is the only encoding which the receiver uses for distinguishing between the component signals, wherein the ground hub is configured to:
(a) determine directivity of the satellite relative to each of the receivers and to the multi-waveform transmitter,
(b) based on any deviation from direct line of sight between the satellite relative to the receivers and the multi-waveform transmitter, calculate an effective power level of the multi-waveform transmitter to compensate for transmission outside an area of maximum coverage of the satellite, and
(c) adjust transmission power of the multi-waveform transmitter, up to a predetermined maximum available power, Pmax to ensure that the combined signal is received by the satellite and that a signal transmitted by the satellite will be received at sufficient signal strength by the ground hub.

46. The system according to claim 45, wherein the receiver extracts the component signals using successive interference cancellation.

47. The system according to claim 45, wherein the ground hub is configured to feed remote prioritization data to the multi-waveform transmitter via the satellite to allow the multi-waveform transmitter to adjust its weighted transmitted power.

48. The system according to claim 45, wherein the ground hub is configured to perform closed power loop control by feeding received signal power level for each component signal back to the multi-waveform transmitter via the satellite to allow the multi-waveform transmitter to adjust its weighted transmitted power.
